(19) United States
(12) Patent Application Publication
(10) Pub. No.: US 2025/0389965 A1
(43) Pub. Date: Dec. 25, 2025

(54) INTELLIGENT HEAD-MOUNTED DEVICE AND HOUSING THEREOF

(71) Applicant: Goertek Inc., Shandong (CN)

(72) Inventors: Meiling LI, Shandong (CN); Chun Li, Shandong (CN); Fengguang Ling, Shandong (CN)

(73) Assignee: Goertek Inc., Shandong (CN)

(21) Appl. No.: 18/880,205

(22) PCT Filed: Mar. 9, 2023
(86) PCT No.: PCT/CN2023/080462

§ 371 Date: Dec. 30, 2024

(30) Foreign Application Priority Data
Jun. 30, 2022 (CN) 202210770695.6

(51) Int. Cl. G02B 27/01

(52) U.S. Cl. CPC G02B 27/0176; G02B 27/0172; G02B 2027/0152

(57) ABSTRACT

Disclosed are a smart head mount device and a housing thereof. The housing comprises a weight-reducing frame by at least a part of the housing The weight-reducing frame is made of at least an organic aerogel material and has a density of 0.4 g/cm³ to 1.3 g/cm³ and a bending modulus greater than 2.5 GPa.

### CROSS-REFERENCE TO RELATED APPLICATIONS

The present disclosure is a National Stage of International Application No. PCT/CN2023/080462, filed on Mar. 9, 2023, which claims priority to Chinese Patent Application No. 202210770695.6, filed on Jun. 30, 2022, both of which are hereby incorporated by reference in their entireties.

### TECHNICAL FIELD

The present disclosure relates to the technical field of a wearable device, and particularly to a housing of a smart head mount device and a smart head mount device with the housing of the smart head mount device.

### BACKGROUND

Wearable devices are becoming increasingly prevalent in life, and user's demands and expectations regarding the experience of using these devices continue to grow. As a common type of a wearable device, the housing of VR is typically made from injection molded materials or carbon fiber composite structures. While these materials offer high strength, their relatively high density significantly increases the weight of the product, thereby diminishing user experience.

### SUMMARY

The present disclosure aims to address at least one of the technical problems in the prior art. To this end, one objective of the present disclosure is to propose a housing of a smart head mount device that has the advantages of high strength and low weight.

Another objective of the present disclosure is to provide an electronic device composed of the above housing of the smart head mount device.

To achieve the above objectives, the present disclosure provides the following technical solutions.

A housing of a smart head mount device according to an embodiment of a first aspect of the present disclosure, at least a part of the housing is formed as a weight-reducing frame, which is made of at least an organic aerogel material and has a density of 0.4 g/cm³ to 1.3 g/cm³ and a bending modulus greater than 2.5 GPa.

According to some embodiments of the present disclosure, the housing is formed as a whole as the weight-reducing frame.

According to some embodiments of the present disclosure, the housing further comprises an auxiliary supporting part, which is bonded with the weight-reducing frame or is integrally formed with the weight-reducing frame to form the housing.

According to some embodiments of the present disclosure, the auxiliary supporting part is prepared from at least one of engineering plastics, stainless steel or lightweight alloys.

According to some embodiments of the present disclosure, the weight-reducing frame further contains a reinforcing material therein, the organic aerogel material being 30% to 90% by mass percentage of a total weight of the weight-reducing frame, and the reinforcing material being 10% to 70% by mass percentage of the total weight of the weight-reducing frame; and/or, the weight-reducing frame has a specific modulus greater than 3.5 GPa·cm³/g.

According to some embodiments of the present disclosure, the organic aerogel material has a matrix skeleton and a porous structure, and the reinforcing material is a reinforcing fiber distributed in the matrix skeleton and the porous structure.

According to some embodiments of the present disclosure, the reinforcing material is at least one of carbon fiber, glass fiber, aramid fiber and PBO fiber.

According to some embodiments of the present disclosure, the reinforcing material is at least one of chopped fiber powder, non-woven felt and fiber fabric.

According to some embodiments of the present disclosure, the reinforcing fiber has a length greater than 1 mm.

According to some embodiments of the present disclosure, the weight-reducing frame has a bending strength greater than 30 MPa.

According to some embodiments of the present disclosure, the weight-reducing frame further contains a thermal conductive filler therein, which is at least one of a metal filler and an inorganic non-metal filler.

According to some embodiments of the present disclosure, the thermal conductive filler has a thermal conductivity greater than 60 W/m·K, and the weight-reducing frame has a thermal conductivity greater than or equal to 0.55 W/m·K.

According to some embodiments of the present disclosure, the weight-reducing frame has a loss factor greater than 0.01.

According to some embodiments of the present disclosure, the organic aerogel comprises at least one of polyimides, polyamides, polyesters, aldehydes, polyolefins and polysaccharides.

According to some embodiments of the present disclosure, the weight-reducing frame is a non-transparent material piece.

According to some embodiments of the present disclosure, the housing comprises: a main housing provided with a wearing part suitable for wearing; and a front shell connected with the main housing and cooperating with the main housing to define an accommodating space, wherein the front shell and at least a part of the main housing are formed as the weight-reducing frame.

A wearable device according to an embodiment of a second aspect of the present disclosure comprises: the housing of a smart head mount device according to any of above embodiments; and an optical lens provided in the housing.

In the housing of the smart head mount device according to the embodiment of the present, by providing at least a part of the housing as including the weight-reducing frame prepared from the organic aerogel material, the interior of the weight-reducing frame prepared from the organic aerogel material has a large number of pores. By controlling the density and bending modulus of the weight-reducing frame, it achieves a lighter mass while still satisfying the demand on stiffness. This results in greater comfort for the user when wearing the device, thereby improving the user experience.

Other features of the present disclosure and advantages thereof will become apparent from the following detailed description of exemplary embodiments of the present disclosure with reference to the accompanying drawings.

### DETAILED DESCRIPTION

Various exemplary embodiments of the present disclosure will now be described in detail with reference to the accompanying drawings. It is to be noted that unless otherwise specified, the scope of present disclosure is not limited to relative arrangements, numerical expressions and values of components and steps as illustrated in the embodiments.

Description to at least one exemplary embodiment is for illustrative purpose only, and in no way implies any restriction on the present disclosure or application or use thereof.

Techniques, methods and devices known to those skilled in the prior art may not be discussed in detail; however, such techniques, methods and devices shall be regarded as part of the description where appropriate.

In all the examples illustrated and discussed herein, any specific value shall be interpreted as illustrative rather than restrictive. Different values may be available for alternative examples of the exemplary embodiments.

It is to be noted that similar reference numbers and alphabetical letters represent similar items in the accompanying drawings. In the case that a certain item is identified in a drawing, further reference thereof may be omitted in the subsequent drawings.

The housing of the smart head mount device according to the embodiment of the present disclosure is first described in detail below.

At least a part of the housing of the smart head mount device according to the embodiment of the present disclosure is formed as a weight-reducing frame, which is made of at least an organic aerogel material and has a density of 0.4 g/cm³ to 1.3 g/cm³ and a bending modulus greater than 2.5 GPa.

In other words, the housing of the smart head mount device according to the embodiment of the present disclosure as a whole may be composed of a weight-reducing frame, or it may be prepared only partially as the weight-reducing frame while the rest of the housing of the smart head mount device is prepared from the conventional material. The weight-reducing frame may also be prepared by adding other reinforcing materials or structures to the organic aerogel material. The density of the weight-reducing frame is controlled from 0.4 g/cm³ to 1.3 g/cm³, for example, it may be 0.4 g/cm³, 0.7 g/cm³, 1 g/cm^{3,} 1.2 g/cm³, 1.3 g/cm³, etc.; the bending modulus of the weight-reducing frame is set to be greater than 2.5 GPa, which may satisfy the demand on stiffness of the housing.

Here, it should be noted that the organic aerogel material is a solid material with a large porosity and a high specific surface area, with most of its volume consisting of air. The density of the weight-reducing frame may be adjusted by controlling parameters such as the porosity and pore size of the organic aerogel material. The bending modulus refers to the ability of a material to resist bending deformation within its elastic limit, that is, the ratio of bending stress to the deformation caused by bending. The bending performance is one of the important physical performance indicators of the housing of the smart head mount device, and the bending modulus is one of the important data for testing whether the quality of the housing satisfies the standards. Generally, a greater bending modulus of the housing indicates stronger stiffness and deformation resistance of the housing. For the weight-reducing frame prepared from the organic aerogel material, its bending modulus may be adjusted by adjusting the porosity and pore size of the organic aerogel material so as to satisfy the demand on a higher bending modulus.

Therefore, in the housing of the smart head mount device according to the embodiment of the present disclosure, by providing at least a part of the housing as including t the weight-reducing frame prepared from the organic aerogel material, the interior of the weight-reducing frame prepared from the organic aerogel material has a large number of pores. By controlling the density and bending modulus of the weight-reducing frame, it achieves a lighter mass while still satisfying the demand on stiffness. This results in greater comfort for the user when wearing the device, thereby improving the user's experience.

The structure of the housing of the smart head mount device may be reasonably set according to the specific need of the smart head mount device to satisfy different usage demand of the user. In some specific embodiments of the present disclosure, the housing comprises: a main housing and a front shell, the main housing is provided with a wearing part suitable for wearing, the front shell is connected with the main housing and cooperates with the main housing to define an accommodating space, where the front shell and at least a part of the main housing are formed as the weight-reducing frame.

In other words, the housing of the smart head mount device according to the embodiment of the present disclosure mainly consists of two parts: the main housing and the front shell. Here, the main housing is provided with a wearing structure for wearing the smart head mount device, such as a headband, temples, etc. The front shell is located in the front of the main housing and cooperates with the main housing to form an accommodating space. The accommodating space may be used to assemble the mainboard, optical components, heat dissipation parts, and other structures of the smart head mount device. The main housing constitutes the main structure of the housing of the smart head mount device, and the weight of the housing of the smart head mount device is also mainly concentrated on the main housing. In the process of preparing the housing, the material composition of the main housing and the front shell may be controlled separately to enable the main housing and the front shell to satisfy different demands on the density and bending modulus.

According to one specific embodiment of the present disclosure, the housing is formed as a whole as the weight-reducing frame.

That is to say, in the present embodiment, the housing of the smart head mount device as a whole is composed of the weight-reducing frame, and the weight-reducing frame is at least prepared from the organic aerogel material. Therefore, the housing of the smart head mount device according to the embodiment of the present disclosure as a whole is prepared from at least organic aerogel material. When the weight-reducing frame as a whole is prepared from the organic aerogel material, the housing of the smart head mount device according to the embodiment of the present disclosure as a whole is also prepared from the organic aerogel material.

Therefore, by composing the housing of the smart head mount device as a whole of the weight-reducing frame, the housing of this structure as a whole is also prepared from the organic aerogel material, which is convenient for preparation and allows for more precise control of the density and bending modulus of the housing, so as to more accurately controlling the stiffness and lightness of the housing, thereby improving the overall designability of the housing of the smart head mount device.

In some specific implementations of the present disclosure, the housing further comprises an auxiliary supporting part, which is bonded with the weight-reducing frame or is integrally formed with the weight-reducing frame to form the housing.

In other words, in the present embodiment, the housing of the smart head mount device does not consist solely of the weight-reducing frame but is composed of two parts: the weight-reducing frame and the auxiliary supporting part. The auxiliary supporting part can either be connected with the weight-reducing frame by bonding, or prepared integrally with the weight-reducing frame.

Here, when the auxiliary supporting part is prepared integrally with the weight-reducing frame, the auxiliary supporting part may be molded in advance, and then embedded into the mold as a prefabricated insert to be injected or molded with the organic aerogel material. Therefore, the preparation methods of the housing of this structure are versatile, which may be flexibly adjusted according to the usage needs and has stronger practicality.

Alternatively, according to one embodiment of the present disclosure, the auxiliary supporting part is prepared from at least one of engineering plastics, stainless steel, or lightweight alloys.

Specifically, the auxiliary supporting part can serve as a skeletal part of the housing of the smart head mount device. By selecting materials such as engineering plastics, stainless steel, or lightweight alloys as the skeletal part of the housing, which may not only improve the overall strength and rigidity of the housing but also form more complex shapes, thereby satisfying the demand of producing different products. The weight-reducing frame constituted by the organic aerogel material may serve as the auxiliary supporting structure of the housing of the smart head mount device, which may reduce the weight of the housing while ensuring the demand on the overall strength and rigidity of the housing.

In some alternative embodiments of the present disclosure, the weight-reducing frame further contains a reinforcing material therein, the organic aerogel material being 30% to 90% by mass percentage of a total weight of the weight-reducing frame, and the reinforcing material being 10% to 70% by mass percentage of the total weight of the weight-reducing frame; and/or, the weight-reducing frame has a specific modulus greater than 3.5 GPa·cm³/g.

That is to say, the weight-reducing frame may be prepared from a combination of the organic aerogel material and the reinforcing material, wherein the percentage of the organic aerogel material in the overall weight of the weight-reducing frame may range from 30% to 90%, and the remaining components may be the reinforcing material. For example, when the mass percentage of the organic aerogel material in the weight-reducing frame is 30%, the mass percentage of the reinforcing material is 70%; when the mass percentage of the organic aerogel material in the weight-reducing frame is 40%, the mass percentage of the reinforcing material is 60%; when the mass percentage of the organic aerogel material in the weight-reducing frame is 50%, the mass percentage of the reinforcing material is 50%; when the mass percentage of the organic aerogel material in the weight-reducing frame is 90%, the mass percentage of the reinforcing material is 10%.

Here, since the organic aerogel material has the porous structure, the mass percentage of organic aerogel material in the weight-reducing frame needs to be at least 30% to achieve continuous matrix reinforcement. If the content of the organic aerogel material is too high, it will lead to a reduction in the overall strength of the weight-reducing frame. Therefore, it is necessary to control the mass fraction of the organic aerogel material in the weight-reducing frame to not exceed 90%, while also controlling the mass fraction of the reinforcing material in the weight-reducing frame to not exceed 70%.

Specific modulus is the ratio of a material's modulus to its density, and is an important indicator of the load-bearing capacity of the material. The greater the specific modulus of the material, the greater its rigidity, and consequently, the rigidity of the parts prepared from the material is also greater. Regarding the weight-reducing frame according to the embodiment of the present disclosure, by adjusting the percentage of the reinforcing material in the weight-reducing frame, it is possible to effectively guarantee the demand on rigidity of the weight-reducing frame.

Therefore, by adding the reinforcing material to the weight-reducing frame and combining it with the organic aerogel material, it is possible to further improve the rigidity and strength of the weight-reducing frame. On the basis of guaranteeing the rigidity and strength of the weight-reducing frame, it is possible to further reduce the amount of material used in the weight-reducing frame, thereby achieving the effect of reducing the overall weight of the housing.

Alternatively, according to one embodiment of the present disclosure, the organic aerogel material has a matrix skeleton and a porous structure, and the reinforcing material is a reinforcing fiber distributed in the matrix skeleton and the porous structure.

Specifically, the weight-reducing frame of the housing of the smart head mount device may be made of a composite of the organic aerogel material and the reinforcing fiber. Here, the organic aerogel material with the porous structure may constitute the auxiliary supporting part of the weight-reducing frame, and the reinforcing fiber is in a fibrous structure and may be evenly distributed within the matrix skeleton and the porous structure of the organic aerogel material, such that the bending modulus of the organic aerogel composite material increases accordingly, and the porosity decreases, which results in an overall increase in density, thereby neither increasing the volume of the weight-reducing frame nor enhancing the strength of the weight-reducing frame.

In some alternative embodiments of the present disclosure, the reinforcing material is at least one of carbon fiber, glass fiber, aramid fiber, and PBO fiber.

Alternatively, the reinforcing material may also be a chopped fiber or continuous fiber in different states, wherein the reinforcing material may be at least one of chopped fiber powder, non-woven felt, and fiber fabric. As a result, the reinforcing material comes from a wide range of sources, at low cost and with strong practicality.

According to one embodiment of the present disclosure, the reinforcing fiber has a length greater than 1 mm. Since the reinforcing fiber is in the fibrous structure, if the length of the reinforcing fiber is too short, it is difficult to support the increasement in the strength, and the reinforcing effect on the weight-reducing frame is poor. Therefore, by controlling the length of the reinforcing fiber, it is possible to guarantee the reinforcing effect on the weight-reducing frame, and thus guarantee the strength of the housing of the smart head mount device.

Considering the deformation or damage issues that may occur during the use of the wearable device, the housing of the smart head mount device has low strength and is prone to deformation and damage, leading to damage of the product. Therefore, it is necessary to guarantee that the housing of the smart head mount device has a certain bending strength. In some specific implementations of the present disclosure, the weight-reducing frame has a bending strength greater than 30 MPa. Therefore, it is possible to guarantee that the housing of the smart head mount device has strong strength and is not prone to deformation and damage.

Alternatively, according to one embodiment of the present disclosure, the weight-reducing frame further contains a thermal conductive filler therein, which is at least one of a metal filler and an inorganic non-metal filler.

Specifically, the thermal conductive filler has a thermal conductivity greater than 60 W/m·K, and the weight-reducing frame has a thermal conductivity greater than or equal to 0.55 W/m·K.

It should be noted that the housing of the smart head mount device typically comprises a main housing and a front cover. The housing is provided with an optical lens therein, which generates heat during operation. To dissipate the heat generated by the optical lens, a thermal conductive filler may be provided inside the weight-reducing frame, that is, the housing of the smart head mount device may be prepared by adding the thermal conductive material to the organic aerogel material. The thermal conductive filler may be one or a mixture of metal fillers or high thermal conductivity inorganic non-metal fillers, preferably boron nitride or graphene.

Thus, by adding the thermal conductive filler to the housing of the smart head mount device, it is possible to improve the thermal conductivity of the housing, thereby enhancing the heat dissipation effect of the wearable device while satisfying the demand for the rigidity and mass of the housing. Here, considering that the main housing will be in direct contact with the human body while the front shell will not be in direct contact with the human body during the wearing of the smart head mount device, an appropriate amount of thermal conductive fillers may be added to the front shell so as to increase its thermal conductivity, thereby preventing heat transfer to the user's body and improving the wearing experience.

In some specific implementations of the present disclosure, the weight-reducing frame has a loss factor greater than 0.01.

The housing of the smart head mount device is mounted with the optical lens therein. The weight-reducing frame of the housing is at least prepared from the organic aerogel material, which has a porous structure. By controlling the loss factor of the weight-reducing frame to have good damping, when stress is applied to the porous structure internal of the organic aerogel material, the skeleton of the organic aerogel material deforms, and the fluid in the porous structure is expelled. Expelling the viscous fluid inside the porous structure requires work, resulting in energy loss. During vibration, mechanical energy is converted into internal energy, thereby protecting the optical lens inside the housing of the wearable device from being damaged by impact.

According to one embodiment of the present disclosure, the organic aerogel comprises at least one of polyimides, polyamides, polyesters, aldehydes, polyolefins, and polysaccharides.

Specifically, aerogel refers to a kind of nano-scale porous solid material formed by sol-gel method in which gas replaces the liquid phase in the gel after drying, and also has the properties of a gel. In the present disclosure, the organic aerogel may be an aerogel made of the organic material with high molecular, not only has the characteristics of being porous and lightweight so as to have a larger chain length compared to the inorganic aerogel material, but also has a certain strength suitable for making a housing satisfying a certain mechanical requirement. In a practical application, one or several of the above organic aerogel material may be selected according to the actual needs of the wearable device, making it more applicable.

In some specific implementations of the present disclosure, the weight-reducing frame is a non-transparent material piece.

That is to say, the housing of the smart head mount device as a whole is made of an opaque material, and the color of the housing may be obtained by adding a material of the corresponding color to the organic aerogel and adjusting them.

The wearable device according to the embodiment of the present disclosure comprises the housing of the smart head mount device according to the above embodiment, and the housing is provided with an optical lens therein. The wearable device may be an electronic device such as VR, which is not limited by the present disclosure.

Since the housing of the smart head mount device according to the embodiment of the present disclosure has the above technical effects, the wearable device according to the embodiment of the present disclosure also has corresponding technical effects. That is, the weight of the wearable device may be greatly reduced to make it more comfortable to wear.

The housing of the smart head mount device of the present disclosure is described in detail below, in conjunction with specific embodiments and comparative example.

### Embodiment

Firstly, preparing an organic aerogel composite material: synthesizing the polyimide hydrogel, and then adding the chopped carbon fiber with a length of 3 mm, with the mass content ratio of the chopped carbon fiber being 50%, so as to obtain the organic aerogel composite material containing the reinforcing fiber.

The prepared organic aerogel composite is injected into the mold and molded into the housing as one piece, then is subjected to freeze-drying and undergoes imidization to produce the final Housing One, with the housing having a porosity of 47%.

### Comparative Example

A Housing Two is made using PC through an integrated injection molding process. The structure and dimension of the Housing Two in the Comparative Example are identical to those of the Housing One in the Embodiment.

The housings prepared in both the Embodiment and the Comparative Example are subjected to tests for mass, bending modulus, and damping. The test results are shown in Table 1.

TABLE 1
Testing results of the housing

| Housing | Embodiment | Comparative Example |
|---|---|---|
| mass/g | 105 | 147 |
| density/g/cm³ | 0.9 | 1.25 |
| bending modulus/GPa | 5.6 | 3.5 |
| specific modulus/GPa · cm³/g | 6.2 | 2.8 |
| loss factor | 0.03 | 0.01 |

It can be seen from the Table 1 that when the structure and dimension are the same in the Embodiment and Comparative Example, the mass of the Housing One made from the organic aerogel composite material in the Embodiment is only 71.5% of the mass of the Housing Two made by injection molding in the Comparative Example, achieving a weight reduction of 28.5%; at the same time, the bending modulus of the Housing One made from the organic aerogel composite material in the Embodiment is 1.6 times the bending modulus of the Housing Two made by injection molding in the Comparative Example; the specific modulus of the Housing One made from the organic aerogel composite material in the Embodiment is 2.2 times the specific modulus of the Housing Two made by injection molding in the Comparative Example. The bending modulus and specific modulus may be used to measure the ability of the product to resist damage, indicating that the Housing One made from the organic aerogel composite material in the Embodiment of the present disclosure not only has better strength and damage resistance, but also, while ensuring the structural design strength of the product, may significantly reduce the product weight to improve the wearing comfort for the user.

By testing the damping of the Housing One made from the organic aerogel composite material in the Embodiment and that of the Housing Two made by injection molding, it can be seen that the Housing One made from the organic aerogel composite material has a loss factor of 0.03, which is greater than the loss factor of the Housing Two made by injection molding in the Comparative Example, indicating that the pore and long chain structure of the organic aerogel composite makes the Housing One have good damping property.

Although the present disclosure has been described in detail in connection with some specific embodiments by way of illustration, those skilled in the art should understand that the above examples are provided for illustration only and should not be taken as a limitation on the scope of the disclosure. Those skilled in the art will appreciate that modifications may be made to the above embodiments without departing from the scope and spirit of the present disclosure. We therefore claim as our disclosure all that comes within the scope of the appended claims.

1. A housing of a smart head mount device, comprises:
a weight-reducing frame which is formed by at least a part of the housing,
wherein the weight-reducing frame comprises an organic aerogel material and has a density of 0.4 g/cm³ to 1.3 g/cm³ and a bending modulus greater than 2.5 GPa.

2. The housing of a smart head mount device according to claim 1, wherein the weight-reducing frame is formed by the housing as a whole.

3. The housing of a smart head mount device according to claim 1, wherein the housing further comprises an auxiliary supporting part, bonded with the weight-reducing frame or integrally formed with the weight-reducing frame to form the housing.

4. The housing of a smart head mount device according to claim 3, wherein the auxiliary supporting part comprises at least one of engineering plastics, stainless steel, or lightweight alloys.

5. The housing of a smart head mount device according to claim 1, wherein the weight-reducing frame further contains a reinforcing material 10 wt. % to 70 wt. % thereof, with the organic aerogel material being 30 wt. % to 90 _wt. % thereof and/or,
the weight-reducing frame has a specific modulus greater than 3.5 GPa·cm³/g.

6. The housing of a smart head mount device according to claim 5, wherein the organic aerogel material has a matrix skeleton and a porous structure, and the reinforcing material is a reinforcing fiber distributed in the matrix skeleton and the porous structure.

7. The housing of a smart head mount device according to claim 6, wherein the reinforcing material comprises at least one of carbon fiber, glass fiber, aramid fiber, and PBO fiber.

8. The housing of a smart head mount device according to claim 6, wherein the reinforcing material comprises at least one of chopped fiber powder, non-woven felt, and fiber fabric.

9. The housing of a smart head mount device according to claim 6, wherein the reinforcing fiber has a length greater than 1 mm.

10. The housing of a smart head mount device according to claim 1, wherein the weight-reducing frame has a bending strength greater than 30 MPa.

11. The housing of a smart head mount device according to claim 1, wherein the weight-reducing frame further comprises a thermal conductive filler therein, which comprises at least one of a metal filler and an inorganic non-metal filler.

12. The housing of a smart head mount device according to claim 11, wherein the thermal conductive filler has a thermal conductivity greater than 60 W/m·K, and the weight-reducing frame has a thermal conductivity greater than or equal to 0.55 W/m·K.

13. The housing of a smart head mount device according to claim 1, wherein the weight-reducing frame has a loss factor greater than 0.01.

14. The housing of a smart head mount device according to claim 1, wherein the organic aerogel material comprises at least one of polyimides, polyamides, polyesters, aldehydes, polyolefins, and polysaccharides.

15. The housing of a smart head mount device according to claim 1, wherein the weight-reducing frame comprises a non-transparent material piece.

16. The housing of a smart head mount device according to claim 1, further comprises:
a housing main body provided with a wearing part suitable for wearing; and
a front shell connected with the housing main body and cooperating with the housing main body to define an accommodating space, wherein the front shell and at least a part of the housing main body are formed as the weight-reducing frame.

17. A wearable device, comprises:
a housing of a smart head mount device according to claim 1; and
an optical lens provided in the housing.
